(19) United States
(12) Patent Application Publication
(10) Pub. No.: US 2014/0010933 A1
(43) Pub. Date: Jan. 9, 2014

(54) Methods, Systems, and Devices for Improving Quality of Cherries Post-Harvest

(71) Applicant: Stemilt Growers LLC, Wenatchee, WA (US)

(72) Inventor: Kyle Mathison, Wenatchee, WA (US)

(73) Assignee: Stemilt Growers LLC, Wenatchee, WA (US)

(21) Appl. No.: 13/925,640

(22) Filed: Jun. 24, 2013

Related U.S. Application Data
(60) Provisional application No. 61/664,317, filed on Jun. 26, 2012.

(51) Int. Cl. A23B 7/16

(52) U.S. Cl. CPC A23B 7/16
USPC 426/310; 99/534

(57) ABSTRACT

Provided herein are methods, systems, and devices for improving the quality of fruit, for example, the quality of cherries. There are methods for improving shelf-life and methods for reducing splitting. The methods comprise applying a product or combination of products to the cherries post-harvest and prior to hydrocooling. Such products include sucrose ester based coatings, osmo-regulators, and/or antitranspirants. The systems for packing comprise: (a) picking cherries and placing the cherries into bins in the field; (b) applying a sucrose ester based coating, an osmo-regulator, or an antitranspirant to the cherries using a device configured to treat one or more cherry bins with a solution containing the sucrose ester based coating, an osmo-regulator, or an antitranspirant; (c) moving cherries through a hydrocooler; and (d) moving cherries into a warehouse and onto a packing line.

### RELATED APPLICATIONS

This application claims priority under 35 U.S.C. 119 (e) to U.S. Provisional Patent Application Ser. No. 61/664,317, entitled “Methods, Systems, and Devices for Improving Quality of Cherries Post-Harvest”, filed Jun. 26, 2012, the disclosure of which is hereby incorporated by reference in its entirety.

### TECHNICAL FIELD

Provided herein are methods and systems for controlling cracking of sweet cherries. Specifically, the invention uses a new methods, systems and/or machine to treat sweet cherries in order to reduce post-harvest cracks, splits, or suture tears.

### BACKGROUND

Sweet cherries are fragile, and have a short life span making it difficult to get cherries from the field to the table in an economically viable manner. One significant challenge in providing quality sweet cherries is preventing cracked or split cherries. Cherry splitting is a common pre-harvest problem associated with rainfall in the last weeks before cherries are harvested. Because sweet cherries are so susceptible to rain cracking the majority of USA grown sweet cherries are produced in areas of very little rainfall (i.e. Central Valley California, Central Oregon, and Central Washington) and a variety of cultural practices are used to prevent splitting losses when rainfall does occur. Post-harvest splitting in sweet cherries is also a serious economic problem, is independent of any “natural events”, and results in significant financial losses for growers and packers. Cherry splitting (or cracking) is typically associated with the fruit coming into contact with water, which moves across the osmotic gradient into the cherry causing it to over expand and split. Although contact with water can cause significant cracking in cherries, the packing process currently requires water for transportation and cleaning To ensure a quality product for the consumer sweet cherries must be quickly cooled after harvest and then washed, sized, and sorted for defects. These processes involve submerging the cherries in water which exacerbates cracking due to the osmotic nature of water. To combat this serious problem packers have employed a variety of cultural practices (variety selection, very cold water, etc.) that aim to prevent or reduce splitting in cherries.

The present invention is directed toward overcoming one or more of the problems discussed above.

### SUMMARY

Provided herein are methods, systems, and devices for improving the quality of cherries after harvest. Improving the quality can include, for example, prolonging shelf-life and reducing splitting.

As such, provided herein are methods of prolonging the shelf life of cherries. In some aspects, the methods comprise applying a product or combination of products to the cherries post-harvest and prior to hydrocooling. In some aspects, the methods comprise applying an osmo-regulator or antitranspirant to the cherries post-harvest and prior to hydrocooling.

Further provided are methods for reducing splitting in cherries. In some aspects, the methods comprise applying a sucrose ester based coating, an osmo-regulator, or an antitranspirant to the cherries post-harvest and prior to hydrocooling.

Also provided are systems of packing cherries. In some aspects, the systems comprise: (a) picking cherries and placing the cherries into bins in the field; (b) applying a sucrose ester based coating, an osmo-regulator, or an antitranspirant to the cherries using a device configured to treat one or more cherry bins with a solution containing the sucrose ester based coating, an osmo-regulator, or an antitranspirant; (c) moving cherries through a hydrocooler; and (d) moving cherries into a warehouse and onto a packing line. In some aspects, step (b) is performed in or near the field where the cherries were picked.

A device configured to treat one or more cherry bins with a solution containing a sucrose ester based coating, an osmo-regulator, or an antitranspirant to the cherries post-harvest and prior to hydrocooling.

### BRIEF DESCRIPTION OF THE DRAWINGS

FIG. 1 shows a significant decrease (54%) in splitting in pre-hydrocooler SemperFresh™ (SF) treated fruit.

FIG. 2 shows that pre-Hydrocooler product treatments had a highly significant effect on sweet cherry fruit quality. As shown in FIG. 2, pre-hydrocooler treatments significantly reduced cherry splitting: RainGard™ reduced splitting approximately 80% while SemperFresh™ reduced splitting 37.5%.

### DESCRIPTION

Post-harvest cracking of sweet cherries is a serious economic problem that results in significant financial losses for fresh cherry packers and growers. To combat this problem the cherry packing industry has employed a number of treatments to cherries that have overtime become standard practice. Ultimately however the need to preserve cherry quality and pack cherries in quantity is a delicate balance. Some practices to preserve cherry firmness and quality (i.e. hydrocooling with very cold water, using water to transport cherries within the warehouse, etc.) do have a negative effect in regards to cherry splitting. While the cherry industry is large with several packers with a normal degree of variation in processes there are “industry standard” practices which are outlined below:
I. Cherries are picked in the field into bins.
II. Cherries (in bins) are transported to the warehouse.
III. Outside the warehouse cherries (in bins) are run through a Hydrocooler, a machine similar to a carwash that uses very cold water to wash the cherries and cool them down.
IV. Cherry bins are moved into the warehouse and the cherries are dumped into the cherry packing line, an industrial line that mostly uses water or conveyer belts to transport cherries through the cherry packing process.

Because sweet cherries are eaten fresh and are highly perishable, sweet cherry packers employ many practices to preserve the fruit. Modified atmosphere packaging, fungicides, and other products are commonly used to preserve cherry freshness in packaging. One common product used in cherry packing is SemperFresh™. SemperFresh™ is a sucrose based ester that, according to the manufacturer, inhibits water loss while allowing gas exchange between the fruit and its environment; reduces weight loss and excess respiration, resulting in firmer cherries with less pitting; keeps cherry stems greener longer due to greater moisture retention; gives sheen to cherries without leaving an oily or greasy film on fruit. SemperFresh™ is commonly applied to sweet cherries at the end of the packing process or in the packing water during the packing process (or both), e.g. step IV above.

Other products contemplated as useful according to the various embodiments include OptiCal™.

Field treatment of sweet cherries, i.e. treatment of the fruit while still on the tree before picking, typically involves the application of fungicides and/or products that prevent cherry cracking due to rain. However, prior to this disclosure, it was unknown to apply packing products after the cherries were harvested but before the cherries arrived at the packing house or warehouse.

Provided herein are methods and systems for treating cherries and other fruit to improve fruit quality. Improved fruit quality can include any one or more of the following: reducing splits, bruises, and pitting, maintaining stem quality and gloss, and prolonged shelf-life of cherries.

Further provided are methods of prolonging the shelf-life of cherries. In some embodiments, the method comprises applying a sucrose ester based coating to the cherries post-harvest and prior to hydrocooling. In some embodiments, the method comprises applying an osmo-regulator or an antitranspirant to the cherries post-harvest and prior to hydrocooling. In some aspects, the osmo-regulator or antitranspirant is selected from the group consisting of di-1-p-menthene, phenylmercuric acetate, abscisic acid, aspirin, silicone oil, and waxes. In some aspects, the sucrose ester based coating is SemperFresh™. In some aspects, the osmo-regulator or antitranspirant is RainGard™. Further coatings useful herein are considered boundaries to water penetration, i.e. the coatings prevent the fruit from absorbing water through the skin.

In some embodiments, the osmo-regulator, antitranspirant, or sucrose ester based coating is applied immediately post-harvest.

Still further provided are methods of reducing splitting in cherries. In some embodiments, the method comprises applying a sucrose ester based coating to the cherries post-harvest and prior to hydrocooling. In some embodiments, the method comprises applying an osmo-regulator or antitranspirant to the cherries post-harvest and prior to hydrocooling.

In some embodiments, systems of packing cherries comprise: (a) picking cherries and placing the cherries into bins in the field; (b) applying a sucrose ester based coating to the cherries using a device configured to treat one or more cherry bins with a solution containing the sucrose ester based coating; (c) transporting the cherries to a warehouse; (d) moving cherries through a hydrocooler; and (e) moving cherries into a warehouse and onto a packing line. Step (b) can be performed in or near the field where the cherries were picked. Step (b) can be performed immediately post-harvest.

In some embodiments, systems of packing cherries comprise: (a) picking cherries and placing the cherries into bins in the field; (b) applying an osmo-regulator or antitranspirant to the cherries using a device configured to treat one or more cherry bins with a solution containing the osmo-regulator or antitranspirant; (c) transporting the cherries to a warehouse; (d) moving cherries through a hydrocooler; and (e) moving cherries into a warehouse and onto a packing line. Step (b) can be performed in or near the field where the cherries were picked. Step (b) can be performed immediately post-harvest.

Also provided herein is a device used to treat cherries in the field post-harvest. In some embodiments, the device is configured to treat one or more cherry bins with a solution containing a sucrose ester based coating, an osmo-regulator, or an antitranspirant to the cherries post-harvest and prior to hydrocooling. In some aspects, the device comprises one or more nozzles for spray application of the coating, osmo-regulator, or antitranspirant.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following example is provided for illustrative purposes only and is not intended to limit the scope of the invention.

### Example 1

The inventor conceived of the idea to add SemperFresh™ to the cherries prior to hydrocooling. This idea was met with skepticism within the Research and Development department of Stemilt Growers LLC, with the main hypothesis being that this expensive product would simply be “washed away” during hydrocooling with no effect on the fruit (positive or otherwise). Further, an added step would not have been thought to provide any additional benefit as the packing process still used SemperFresh™ treatment once the cherries arrived in the warehouse.

Despite the skepticism of any effect a machine was built with the ability to apply SemperFresh™ or other products to the cherries immediately post-harvest. Experiments were performed to test the effect of pre-treating cherries with product while still in the field and prior to the hydrocooler. The methodology and results are as follows:

Idea: Using SemperFresh™, RainGard™ or other products before the hydrocooler will be beneficial to cherry fruit quality.

R&D Hypothesis: Applying products pre-hydrocooler will not affect fruit in any way; the product will be washed off of fruit during hydrocooling and duplicates the treatment once the cherries arrive in the warehouse.

### Methods

Preparation: A pre-hydrocooler liquid product application machine was constructed at the Stemilt Hill packing facility. This application machine is capable of treating three to five cherry bins at a time using 1000 L of liquid sprayed through multiple nozzles. The liquid is captured after application for multiple reuses if desired. The application process is summarized below:

### SemperFresh Pre-Hydro Directions

1. Fill Tank to 1000 L
   a. Turn tank heat on night before so tank is at 75 F the next morning
   b. Fill level line is designated in tank
2. Pre-Mix 4 L of SemperFresh in warm water in 5 gal bucket.
   a. Mix with electric paint stirrer
3. When product is in slurry add to 1000 L in tank
4. When slurry has been mixed with 1000 L tank for 3 minutes check tank water with refractometer. Solution should be at 0.5-1%.
   Forklift drivers should wait 20 seconds before moving stack to hydro-cooler.

### Test 1—Initial Testing of Pre-Hydrocooler Applications With SemperFresh™

Methods: fruit from multiple lots of Stemilt Grower KMO3—were split into two groups: treated (SemperFresh™ applied pre-hydrocooler) or control (no pre-hydrocooler treatment). Treatment applications were randomly applied and fruit was sampled from packed boxes at the end of the packing process. The sampled packed boxes were then placed in storage for immediate, 7 day, and 14 day sampling. Three packed 20 lb boxes were sampled at each date and 100 fruit were subsampled from each box. Sampled fruit were inspected for splits, bruises, pitting, stem quality and gloss. Splits, bruises, pitting, and stem quality were visually estimated or counted. Gloss was measured using a model CM-2500d Konica Minolta spectrophotometer with Color Data Software CM-S100w (SpectraMagic NX Pro; Ver. 2.1, Release No. 1), gloss was measured at an 8 degree angle from the perpendicular. Statistical analyses were performed using the stats package R version 2.1, affects were considered significant at p<0.05.

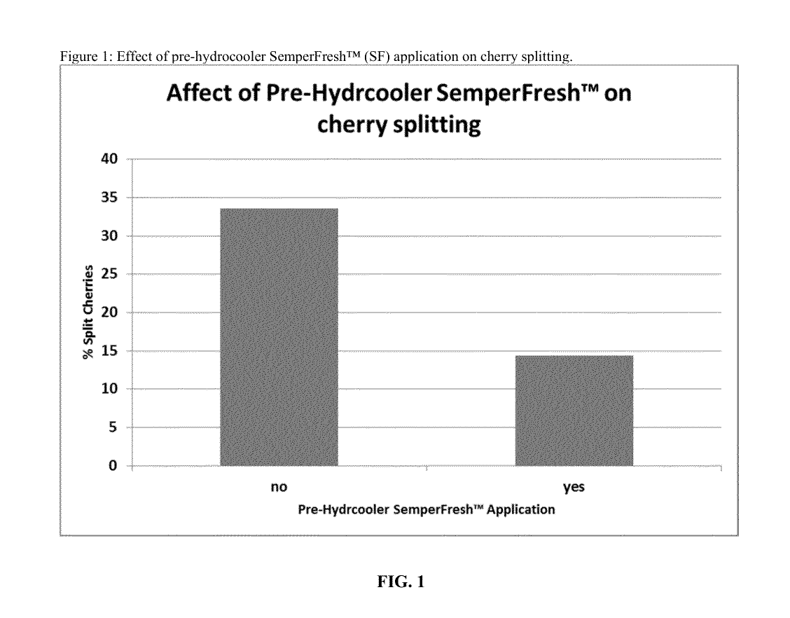

Results: Results from this trial are displayed in FIG. 1. There was a significant decrease (54%) in splitting in pre-hydrocooler SemperFresh™ (SF) treated fruit.

Discussion: Surprisingly and unexpectedly, SemperFresh™ applied pre-hydrocooler had a highly significant effect on cherry fruit quality. While pre-hydrocooler SemperFresh™ application had no effect on cherry bruising, stem color or gloss (p>0.05) there was a significant effect of pre-hydrocooler SemperFresh™ application on cherry splitting. Pre-hydrocooler applied SemperFresh™ significantly reduced splitting in cherries for this trial (p<0.0) and showed a 54% reduction in splitting.

Conclusion: Pre-hydrocooler application of SemperFresh™ significantly improved cherry fruit quality after packing.

### Test 2—Follow Up Research

Background: The purpose of this research was to validate the previous pre-hydrocooler product application experiment and further explore the application of products to cherries before processing in the hydrocooler.

Methods: Sweet cherries packed at three different packing facilities from multiple growers and grower lots were exposed to the following treatments: treated with SemperFresh pre-hydrocooler, treated with RainGard™ post-harvest but pre-hydrocooler, or Control (no pre-hydrocooler treatment). Treatments were applied randomly throughout the packing process and samples of packed fruit were taken throughout the month-long experiment. Randomly chosen samples consisted of three packed 20 lb boxes of cherries, each box was sampled at day 1, day 7, or day 14 after packing to ensure all possible treatment effects were captured.

Sampled boxes were visually evaluated for pitting, splits, bruise and stem color. Sampled fruit were inspected for splits, bruises, pitting, stem quality and gloss. Splits, bruises, pitting and stem quality were visually estimated or counted. Gloss was measured using a model CM-2500d Konica Minolta spectrophotometer with Color Data Software CM-S100w (SpectraMagic NX Pro; Ver. 2.1, Release No. 1), gloss was measured at an 8 degree angle from the perpendicular. Statistical analyses were performed using the stats package R version 2.1, affects were considered significant at p<0.05.

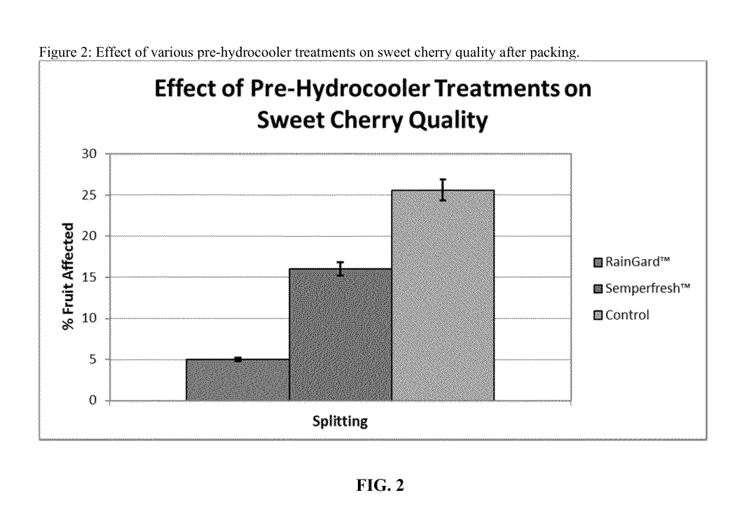

Results: Results from this trial are displayed in FIG. 2.

Discussion: Pre-Hydrocooler product treatments had a highly significant effect on sweet cherry fruit quality. As shown in FIG. 2, pre-hydrocooler treatments significantly reduced cherry splitting: RainGard™ reduced splitting approximately 80% while SemperFresh™ reduced splitting 37.5%.

Conclusions: Surprisingly and contrary to expectations, treatment of sweet cherries prior to hydrocooling with RainGard™ or SemperFresh™ can significantly improve cherry quality.

What is claimed is:

1. A method of prolonging the shelf life of cherries, the method comprising applying a product or combination of products to the cherries post-harvest and prior to hydrocooling.

2. A method of prolonging the shelf life of cherries, the method comprising applying an osmo-regulator or antitranspirant to the cherries post-harvest and prior to hydrocooling.

3. The method of claim 2, wherein the antitranspirant is selected from the group consisting of OptiCal™ or RainGard™.

4. The method of claim 2, wherein the antitranspirant is di-1-p-menthene.

5. The method of claim 1 or 2, wherein the applying is performed within 4 hours post-harvest.

6. A system of packing cherries comprising:
(a) picking cherries and placing the cherries into bins in the field;
(b) applying a sucrose ester based coating to the cherries using a device configured to treat one or more cherry bins with a solution containing the sucrose ester based coating;
(c) moving cherries through a hydrocooler; and
(d) moving cherries into a warehouse and onto a packing line;
wherein step (b) is performed in or near the field where the cherries were picked.

7. The system of claim 6, wherein step (b) is performed within 4 hours post-harvest.

8. A method of reducing splitting in cherries, the method comprising applying a sucrose ester based coating to the cherries post-harvest and prior to hydrocooling.

9. A method of reducing splitting in cherries, the method comprising applying an osmo-regulator or antitranspirant to the cherries post-harvest and prior to hydrocooling.

10. The method of claim 9, wherein the osmo-regulator or antitranspirant is selected from the group consisting of di-1-p-menthene, phenylmercuric acetate, abscisic acid, aspirin, silicone oil, and waxes.

11. The method of claim 9, wherein the antitranspirant is di-1-p-menthene.

12. The method of claim 8 or 9, wherein the applying is performed within 4 hours post-harvest.

13. A device configured to treat one or more cherry bins with a solution containing a sucrose ester based coating, an osmo-regulator, or an antitranspirant to the cherries post-harvest and prior to hydrocooling.

14. The device of claim 13 comprising one or more nozzles for spray application of the coating.

15. The device of claim 13 comprising means for drench or cascade application of the coating.

16. The method of claim 1 or 2, wherein the applying is performed by spray application, drench application, or cascade application.

17. The method of claim 1, wherein the product is a sucrose ester based coating.
